(19) United States
(12) Patent Application Publication
(10) Pub. No.: US 2020/0005650 A1
(43) Pub. Date: Jan. 2, 2020

(54) METHOD OF CONTROLLING PLATOONING IN AUTONOMOUS DRIVING SYSTEM

(71) Applicant: LG ELECTRONICS INC., Seoul (KR)

(72) Inventor: Yongsoo PARK, Seoul (KR)

(21) Appl. No.: 16/563,267

(22) Filed: Sep. 6, 2019

(30) Foreign Application Priority Data
Jul. 30, 2019 (KR) 10-2019-0092763

(51) Int. Cl. G08G 1/00; H04W 4/46; H04B 7/185; H04W 24/02; G05D 1/00; G05D 1/02; B60W 30/14; B64C 39/02

(52) U.S. Cl. CPC G08G 1/22; H04W 4/46; H04B 7/18504; H04W 24/02; H04W 84/042; G05D 1/0291; B60W 30/14; B64C 39/02; G05D 1/0088

(57) ABSTRACT

The present invention provides a method of controlling platooning in an autonomous driving system that can cope with occurrence of a communication blind spot in platooning. In an aspect, a method of controlling platooning in which following vehicles receiving and driving a control signal from a leader vehicle and a communicator of the leader vehicle drive in a group includes monitoring and digitizing a communication status of the platooning; checking, if the digitized communication status is less than a predetermined threshold value, a communication blind spot between the leader vehicle and the following vehicle; determining, when the following vehicle is positioned at the communication blind spot, whether a relative position change of the following vehicle is available within the platooning; and changing, if a relative position change of the following vehicle is available, a relative position of the following vehicle within the platooning.

### CROSS-REFERENCE TO RELATED APPLICATION

This application claims priority under 35 U.S.C. 119 to Korean Patent Application No. 10-2019-0092763, filed on Jul., 30, 2019, the contents of which are incorporated by reference herein in their entirety.

### BACKGROUND OF THE INVENTION

### Field of the invention

The present invention relates to a method of controlling platooning in an autonomous driving system, and more particularly, to a method of controlling platooning in an autonomous driving system that can improve a communication blind spot.

### Related Art

Vehicles may be classified into an internal combustion engine vehicle, an external combustion engine vehicle, a gas turbine vehicle, an electric vehicle, and the like according to the type of motor used.

In recent years, studies for an autonomous vehicle capable of driving by itself in a state in which some or all manipulations by a driver are excluded have been actively conducted.

In an autonomous driving system, a research on platooning that controls a large number of vehicles in a group is being actively conducted. In particular, it is required to prepare for a case where communication between a plurality of vehicles is not smooth in platooning.

### SUMMARY OF THE INVENTION

The present invention has been made in an effort to solve the above problems.

The present invention provides a method of controlling platooning in an autonomous driving system that can cope with occurrence of a communication blind spot in platooning.

In an aspect, a method of controlling platooning in which following vehicles receiving and driving a control signal from a leader vehicle and a communicator of the leader vehicle drive in a group includes monitoring and digitizing a communication status of the platooning; checking, if the digitized communication status is less than a predetermined threshold value, a communication blind spot between the leader vehicle and the following vehicle; determining, when the following vehicle is positioned at the communication blind spot, whether a relative position change of the following vehicle is available within the platooning; and changing, if a relative position change of the following vehicle is available, a relative position of the following vehicle within the platooning.

The checking of a communication blind spot may include determining, when the communicator of the leader vehicle is positioned at an upper portion of the vehicle, that the following vehicle is positioned at the communication blind spot, if heights of the leader vehicle and the following vehicle are different from a driving route.

The changing of a relative position of the following vehicle may include increasing a distance between the leader vehicle and the following vehicle.

The checking of a communication blind spot may include determining, when the communicator of the leader vehicle is disposed at a side mirror of the vehicle, that the following vehicle is positioned at the communication blind spot, if a heading direction of the leader vehicle is greater than or equal to a predetermined threshold angle.

The changing of a relative position of the following vehicle may include changing a lane of the leader vehicle or the following vehicle.

The method may further include calling, after the determining of whether a relative position change of the following vehicle, an unmanned aerial vehicle for relaying the control signal from the leader vehicle, if a relative position change of the following vehicle is unavailable.

The platooning may include a plurality of following vehicles, and the calling of an unmanned aerial vehicle may include calling a first unmanned aerial vehicle for relaying first group following vehicles among the following vehicles, and a second unmanned aerial vehicle for receiving a control signal from the first unmanned aerial vehicle and relaying second group following vehicles among the following vehicles.

The platooning may classify following vehicles having a poor communication status into the second group following vehicles.

The method may further include setting a flight position of the second unmanned aerial vehicle such that the sum of separation distances between the second unmanned aerial vehicle and each of the second group following vehicles is a minimum.

The monitoring and digitizing of a communication status may include counting a communication failure period in which the communication status is remained to a value less than the threshold value; and changing, when the communication failure period is equal to or greater than a predetermined threshold time, a communication frequency of the platooning to a frequency of low directivity.

The monitoring and digitizing of a communication status may include determining latency in 5G communication, and the changing of a communication frequency may include changing from a frequency of 5G communication to an LTE-based frequency.

The platooning may perform communication based on 5G communication, and the method may further include, after calling the unmanned aerial vehicle, calculating communication latency of the following vehicle; changing, when a period in which the communication latency is greater than or equal to a predetermined threshold time reaches a predetermined period, a communication means of the platooning to LTE-based communication.

The method may further include calling, if the following vehicle is not positioned at the communication blind spot, an unmanned aerial vehicle for relaying the control signal from the leader vehicle.

The method may further include defining a corresponding driving region to a communication blind spot and storing position information of the communication blind spot.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram illustrating platooning in an autonomous driving system.

FIG. 10 is a flowchart illustrating a method of controlling platooning in an autonomous driving system according to an embodiment of the present invention.

FIGS. 11 and 12 are diagrams illustrating a communication blind spot.

FIGS. 13 and 14 are diagrams illustrating communication relay using an unmanned aerial vehicle.

FIG. 15 is a flowchart illustrating an embodiment of changing relative positions of vehicles in platooning.

FIGS. 16A to 17B are diagrams illustrating embodiments according to a position of a communicator.

FIG. 18 is a diagram illustrating an embodiment of a flying position of unmanned aerial vehicles.

FIG. 19 is a flowchart illustrating a procedure of calling an unmanned aerial vehicle in an autonomous driving system.

FIG. 20 is a flowchart illustrating a procedure of withdrawing an unmanned aerial vehicle in an autonomous driving system.

FIG. 21 is a flowchart illustrating an embodiment of changing a communication frequency.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

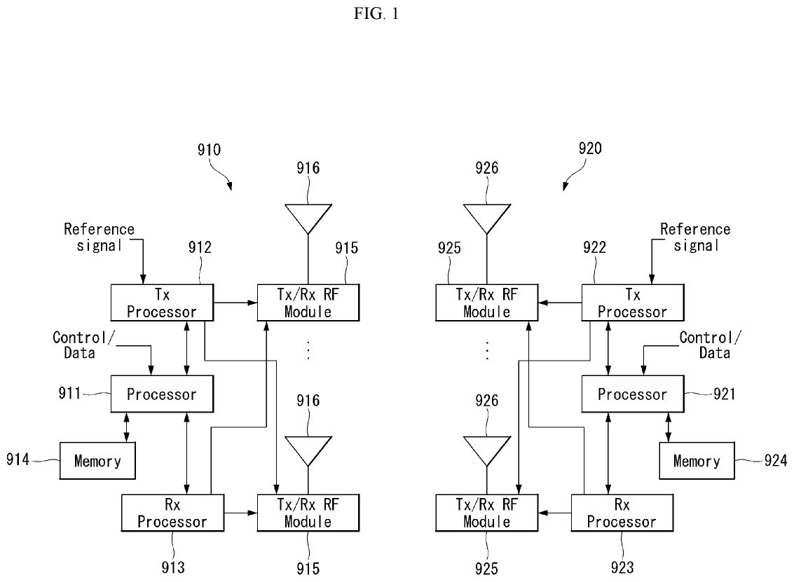

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HIVID)), etc. For example, the HMD may be a display device worn on the head of a user. For example, the HIVID may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

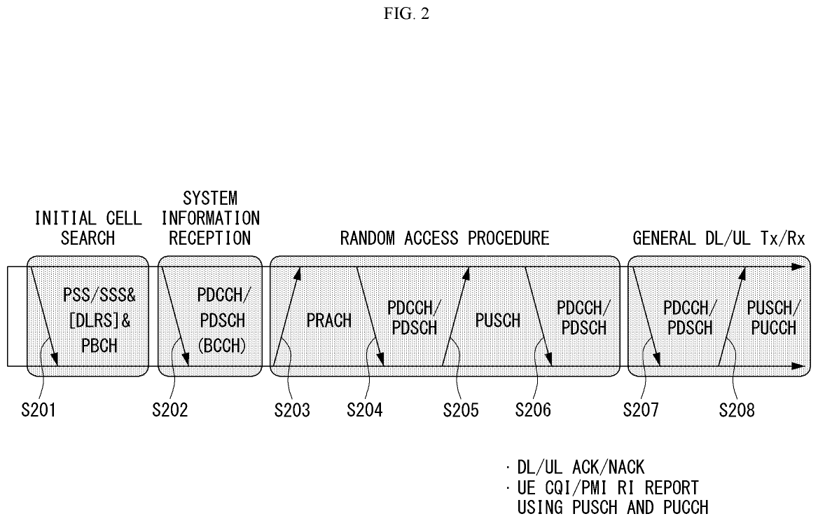

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the B S or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles using 5G Communication

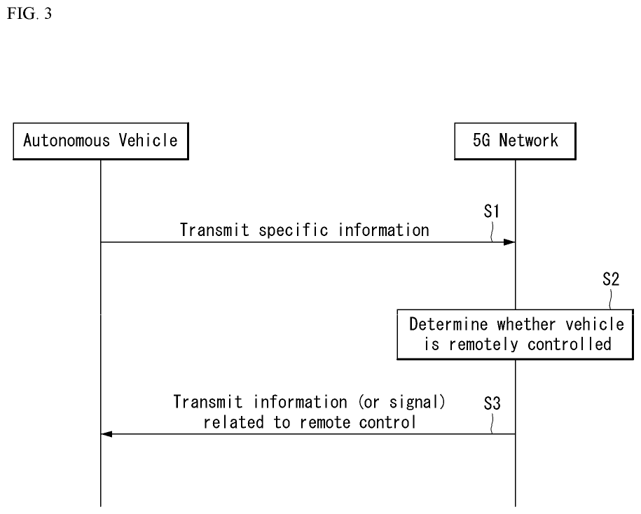

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps 51 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles using 5G Communication

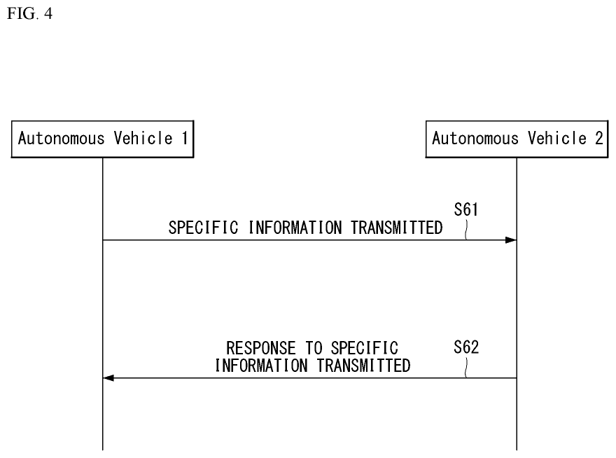

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

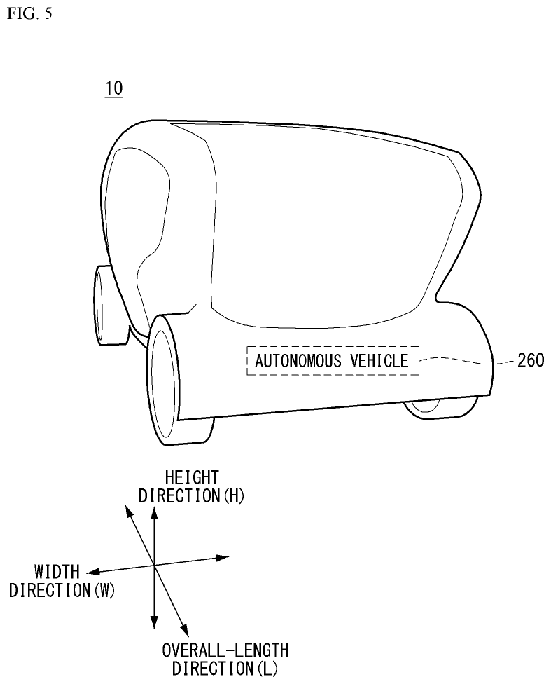

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

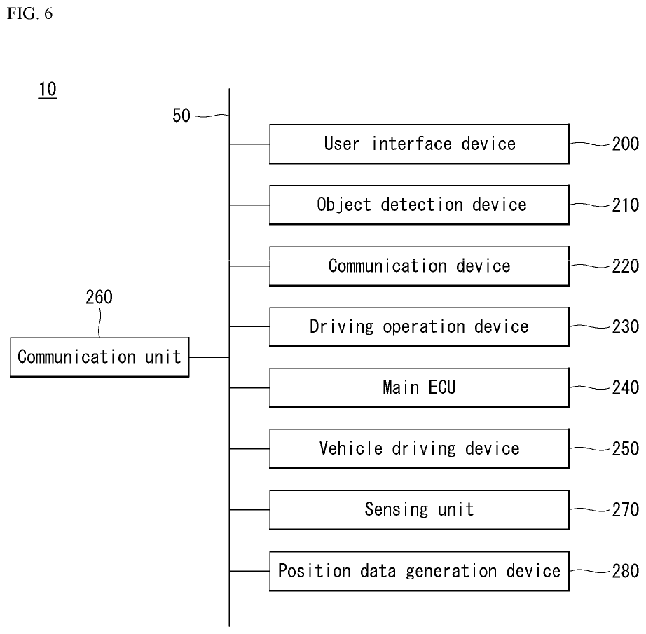

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

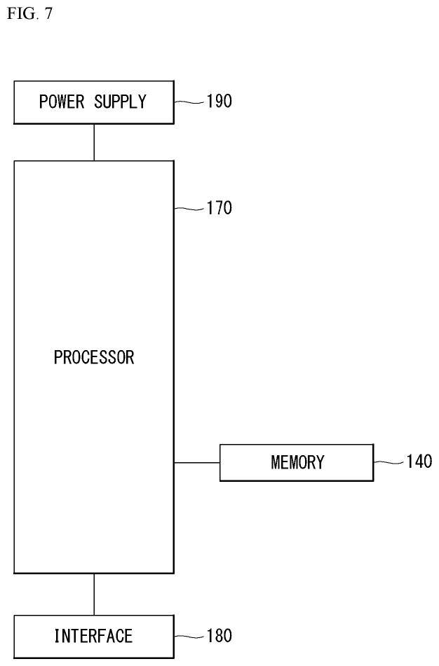

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

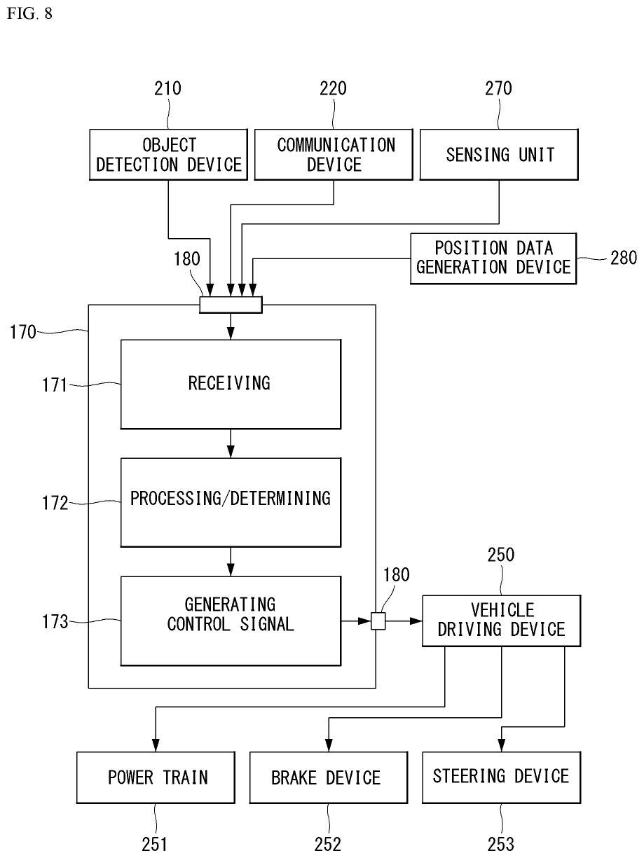

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

The 5G technology described above may be applied in combination with methods proposed in the present invention to be described later or may be supplemented to specify and clarify technical features of the methods proposed in the present invention.

Hereinafter, various embodiments of the present invention will be described in detail with reference to the accompanying drawings.

Platooning System

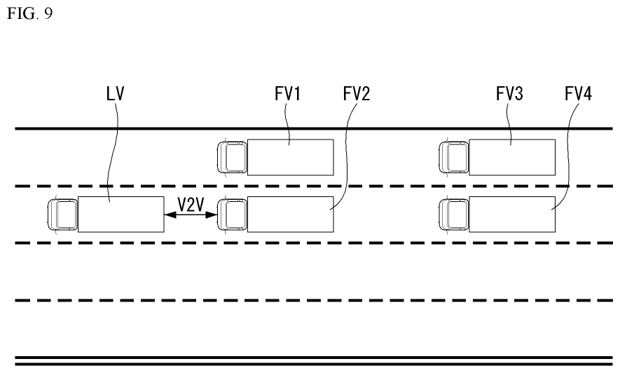

FIG. 9 is a diagram illustrating platooning in an autonomous driving system.

Referring to FIG. 9, platooning indicates driving of a plurality of vehicles in a group and may include a leader vehicle LV and following vehicles FV1 to FV4.

The leader vehicle LV and the following vehicles FV1 to FV4 may perform vehicle to vehicle (V2V) communication using respective communicators. FIG. 9 illustrates V2V communication between the leader vehicle LV and the second following vehicle FV2, but other following vehicles FV1 and FV3 to FV5 may also perform V2V communication with the leader vehicle LV

The leader vehicle LV may control one or more following vehicles FV1 to FV4. The leader vehicle LV transmits a control signal for controlling the following vehicle to the following vehicles FV1 to FV4.

The following vehicles FV1 to FV4 may drive according to a control signal received from the leader vehicle LV. That is, the controller of the following vehicles FV1 to FV4 controls a vehicle driving device based on a control signal provided by the leader vehicle. The following vehicles FV1 to FV4 provide information about positions and operating states thereof to the leader vehicle LV. The leader vehicle LV may determine positions and operating states of the following vehicles FV1 to FV4 based on the information provided by the following vehicles FV1 to FV4.

A communication status between the leader vehicle LV and the following vehicles FV1 to FV4 may be referred to as a group communication status, and the group communication status is monitored during platooning.

A communication status of platooning may be determined based on at least one of channel congestion, reception sensitivity, a packet error ratio (PER), received signal strength indication (RSSI), a signal to noise ratio (SNR), and signal-to-interference-plus-noise ratio (SINR).

Channel congestion represents a use degree of a specific frequency bandwidth used for communication between the leader vehicle LV and the following vehicles FV1 to FV4. For example, as more data is transmitted through a specific frequency bandwidth, it may be regarded that channel congestion increases.

Reception sensitivity is reception sensitivity of the leader vehicle LV or the following vehicles FV1 to FV4. Reception sensitivity is determined according to a bit error rate (BER). The bit error rate is a probability that an error will occur in transmitted data.

The communication status of the group may be expressed in a communication level representing a smooth degree of communication. For example, as the communication status is smooth, the communication level may be expressed in a large value. The communication status may be determined by any one of the leader vehicle LV or the following vehicles FV1 to FV4 or may be determined using an infrastructure installed on a road.

Method of Controlling Platooning

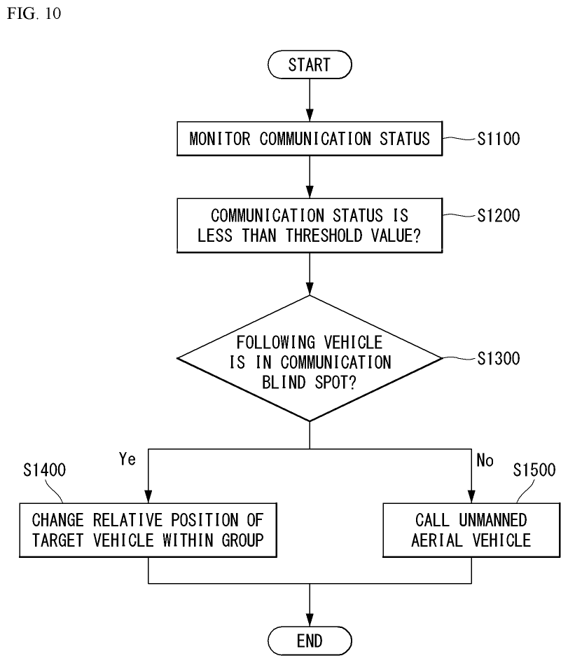

FIG. 10 is a flowchart illustrating a method of controlling platooning in an autonomous driving system according to an embodiment of the present invention. Hereinafter, the following vehicle FV may be any one of the following vehicles FV1 to FV4 of FIG. 9.

Referring to FIG. 10, in first step S1100, a communication status is monitored.

A communication status may be determined based on at least one of channel congestion, reception sensitivity, a packet error ratio (PER), received signal strength indication (RSSI), a signal to noise ratio (SNR), and signal-to-interference-plus-noise ratio (SINR). Determination of the communication status may be performed by the leader vehicle LV or the following vehicle FV or may be performed by a server (not illustrated).

The communication status may be expressed with a numerical value, and step of monitoring a communication status includes step of monitoring a magnitude of a numerical value. In the present specification, an embodiment will be described in which a communication status is good as a numerical value is large and in which a communication status is poor as a numerical value is small.

In second step S1200, the communication status is compared with a threshold value. That is, the digitized communication status is compared with a predetermined threshold value. The threshold value is a criterion for determining whether the communication status is smooth.

In third step S1300, it is determined whether the following vehicle is in a communication blind spot. The communication blind spot indicates an area in which a propagation path from a communicator of a leader vehicle that transmits a control signal is blocked by a vehicle body. Therefore, the communication blind spot may vary depending on a position of the communicator mounted in the leader vehicle. Further, the communication blind spot may be changed by a heading direction of the leader vehicle or a height difference between the leader vehicle and the following vehicle. An example of a communication blind spot will be described with reference to the drawing as follows.

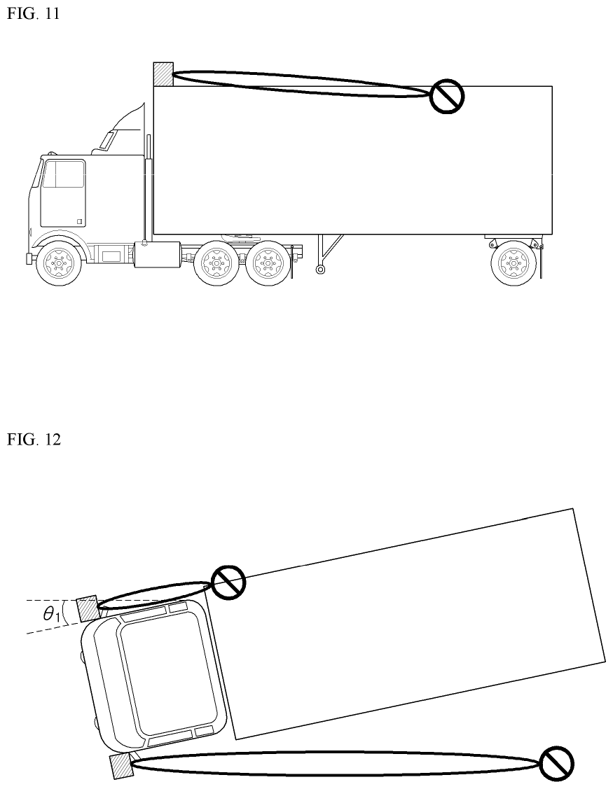

FIGS. 11 and 12 are diagrams illustrating a communication blind spot.

FIG. 11 is a diagram illustrating a communication blind spot when a communicator is positioned at an upper part of a leader vehicle.

Referring to FIG. 11, when the communicator of the leader vehicle LV is positioned at an upper part of a vehicle body, radio waves having strong directivity are covered by the leader vehicle LV to be not transmitted to a lower place.

FIG. 12 is a diagram illustrating a communication blind spot when a communicator is mounted in a side mirror of a leader vehicle.

Referring to FIG. 12, when the communicator of the leader vehicle LV is mounted in the side mirror, a communication blind spot may occur according to a heading direction of the leader vehicle LV. For example, when an angle of deviation θ1 between the heading direction of the leader vehicle LV and the vehicle body is biased by a threshold angle or more to the left, the following vehicle positioned at a right lane of the leader vehicle LV may enter the communication blind spot.

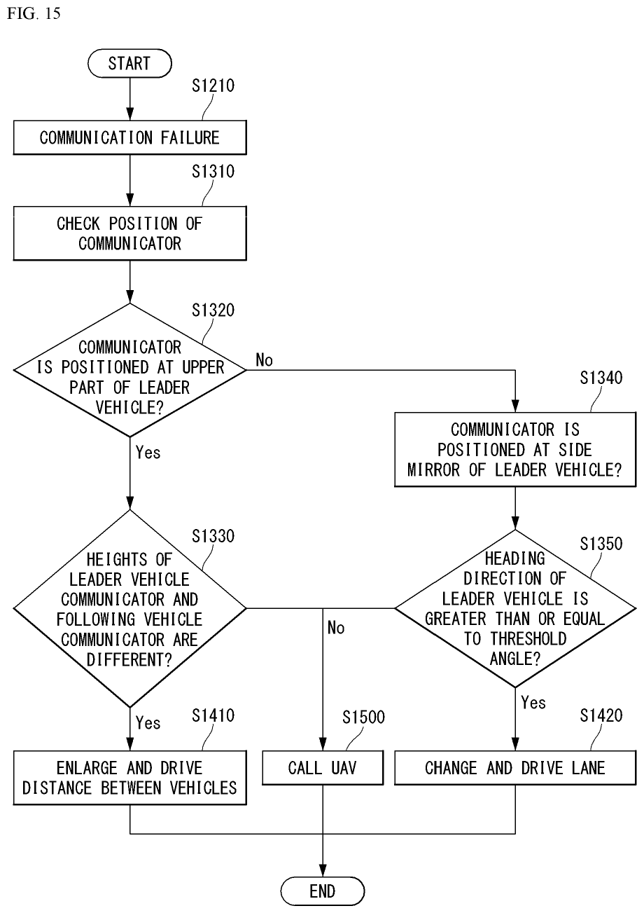

In fourth step S1400, when the following vehicle FV is positioned at the communication blind spot, a relative position of vehicles within the group is changed. An embodiment in which a communication failure changes a relative position of the following vehicle FV will be described later with reference to the flowchart of FIG. 15.

In fifth step S1500, an unmanned aerial vehicle (UAV) is called. The fifth step S1500 may correspond to a communication failure that is not identified based on a vehicle body or a driving position of the leader vehicle LV or the following vehicle FV.

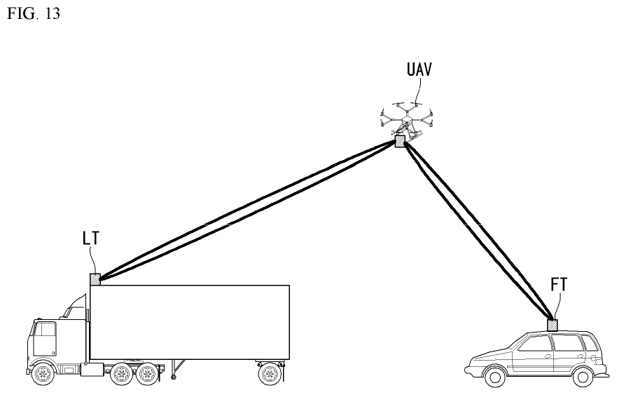

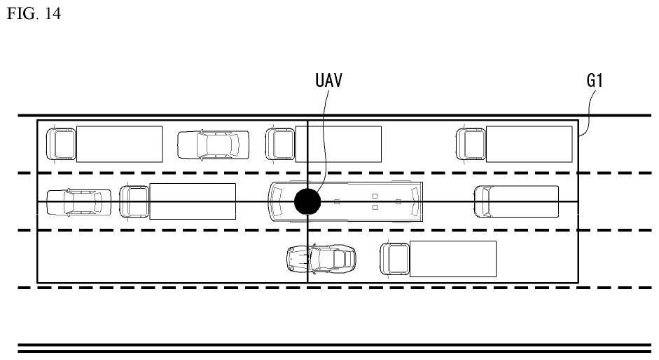

FIGS. 13 and 14 are diagrams illustrating communication relay using an UAV.

Referring to FIGS. 13 and 14, the UAV may fly at a position higher than heights of a leader vehicle communicator LT and a following vehicle communicator FT, receive a control signal from the leader vehicle communicator LT, and transmit the control signal to the following vehicle communicator FT. The UAV flies at a position that can smoothly perform communication with all vehicles that perform platooning in consideration of a size of platooning. For example, as illustrated in FIG. 15, the UAV may fly in a state positioned at the center of a group G1 in platooning.

FIG. 10 illustrates an embodiment of calling an UAV when a vehicle does not correspond to a communication blind spot, but even when a relative position change of the following vehicle is unavailable in fourth step S1400, the UAV may be called.

FIG. 15 is a flowchart illustrating an embodiment of changing relative positions of vehicles in platooning.

Referring to FIG. 15, first, at step S1210, a communication failure between the leader vehicle and the follower vehicle is checked.

In step S1310, a position of the communicator is checked.

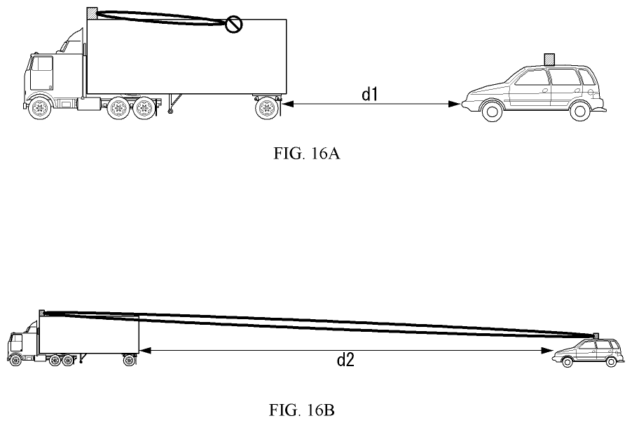

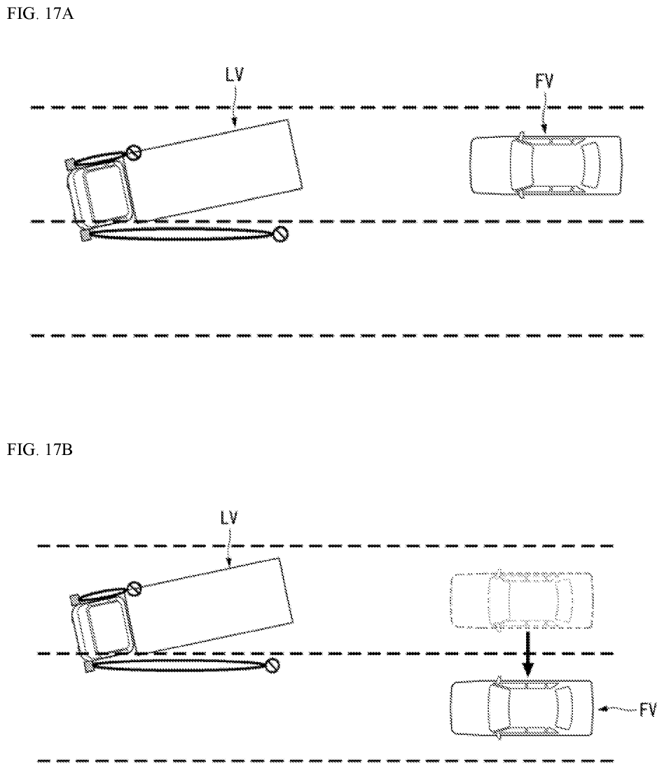

FIGS. 16A to 17B are diagrams illustrating embodiments according to a position of a communicator.

Referring to FIGS. 16A and 16B, at steps S1320 and S1330, while the communicator is positioned at an upper part of the leader vehicle LV, it is checked whether heights of the leader vehicle communicator LT and the following vehicle communicator FT are different. The height of the leader vehicle communicator LT means a height of the leader vehicle communicator LT from a driving surface R1, and a height of the following vehicle communicator FT means a height of the leader vehicle communicator LT from a driving surface R1. The heights of the leader vehicle communicator LT and the following vehicle communicator FT may vary depending on the difference in a height of a vehicle body of the leader vehicle LV and the following vehicle FV or an inclination of the driving surface R1.

In step S1410, a distance between the leader vehicle LV and the following vehicle FV is widely secured. For example, by increasing the distance between the leader vehicle LV and the following vehicle FV from “d1” of FIG. 16A to “d2” of FIG. 16B and performing platooning, the vehicles may deviate from a communication blind spot caused by the height difference of the communicator.

Referring to FIGS. 17A and 17B, in steps S1340 and S1350, while the communicator is positioned at a side mirror of the leader vehicle LV, it is determined whether an angle of deviation between a heading direction of the leader vehicle LV and the vehicle body is greater than or equal to a threshold angle.

In S1420, by changing a lane to the heading direction of the leader vehicle LV, the following vehicle FV may leave a communication blind spot.

Separately from step S1350, in some cases, due to a vehicle width of the leader vehicle LV itself, the following vehicle FV may be positioned at a communication blind spot regardless of a heading direction of the leader vehicle LV. In this way, in order to deviate from a communication blind spot due to a difference in a vehicle width of the leader vehicle LV and a vehicle width of the following vehicle FV, the following vehicle FV may change a lane. Alternatively, as illustrated in FIG. 16B, by widening a distance from the leader vehicle LV, the following vehicle FV may deviate from the blind spot.

Step S1500 is a procedure of calling the UAV and corresponds to fifth step S1500 of FIG. 10. Step S1500 means a communication failure state, although the following vehicle FV is not positioned at the communication blind spot. At step S1500, when a cause of the communication unavailability is not determined, an UAV may be called.

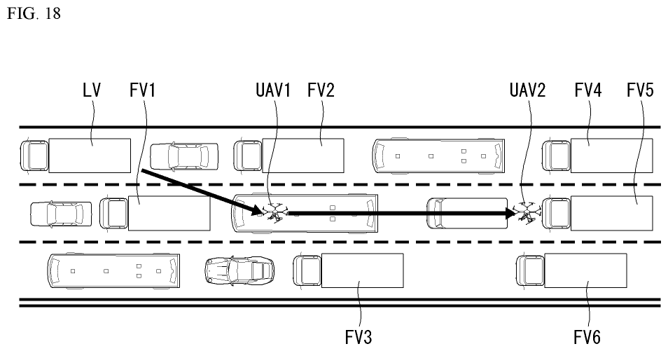

FIG. 18 is a diagram illustrating an embodiment of a flying position of UAVs.

As described in FIG. 15, one UAV may fly at a central position of a group G1. Unlike FIG. 15, in some cases, a plurality of UAVs may be used, and flight positions of the plurality of UAVs may be as follows.

Referring to FIG. 18, platooning may include a leader vehicle LV and a plurality of following vehicle FV1 to FV6.

According to a form of platooning, many UAVs may be used. For example, as the number of vehicles constituting a group is large, when a communication capacity of the UAV is much required, a plurality of UAVs UAV1 and UAV2 may be called. Alternatively, in order to solve a communication blind spot according to a form of platooning, a plurality of UAV1 and UAV2 may be called. Alternatively, when a communication frequency band of the following vehicles is different or when a communication method is different, the plurality of UAV1 and UAV2 may be called.

The first UAV1 receives a control signal from the leader vehicle LV and transmits the control signal to the first group following vehicles FV1 to FV3 and the second UAV2. The first UAV1 may control each of the first group following vehicles FV1 to FV3.

The second UAV2 receives a control signal from the first UAV1 and transmits the control signal to the second group following vehicles FV4 to FV6. The second UAV2 may control each of the second group following vehicles FV4 to FV6.

The first group following vehicles FV1 to FV3 and the second group following vehicles FV4 to FV6 may be classified according to a communication status. For example, the first group following vehicles FV1 to FV3 may be formed with following vehicles having a good communication status, and the second group following vehicles FV4 to FV6 may be formed with following vehicles having a poor communication status. In this case, the first UAV1 may fly with positioned at the center of the first group following vehicles FV1 to FV3 or at the center of the entire group. In order to efficiently relay following vehicles in a poor communication status, the second UAV2 may fly with positioned at the center of the second group following vehicles FV4 to FV6. For example, a flight position of the second UAV2 may be set so that the sum of separation distances between the second UAV2 and each of the second group following vehicles FV4 to FV6 is a minimum.

Unlike the embodiment illustrated in FIG. 18, the first group following vehicles and the second group following vehicles are configured with the same number, and the first and second UAVs may fly with positioned at the center of the group following vehicles relaying the UAVs.

FIG. 18 illustrates an embodiment in which following vehicles of a group are divided into a first group and a second group, but the number of groups and the number of UAVs may vary according to the number of following vehicles constituting a group.

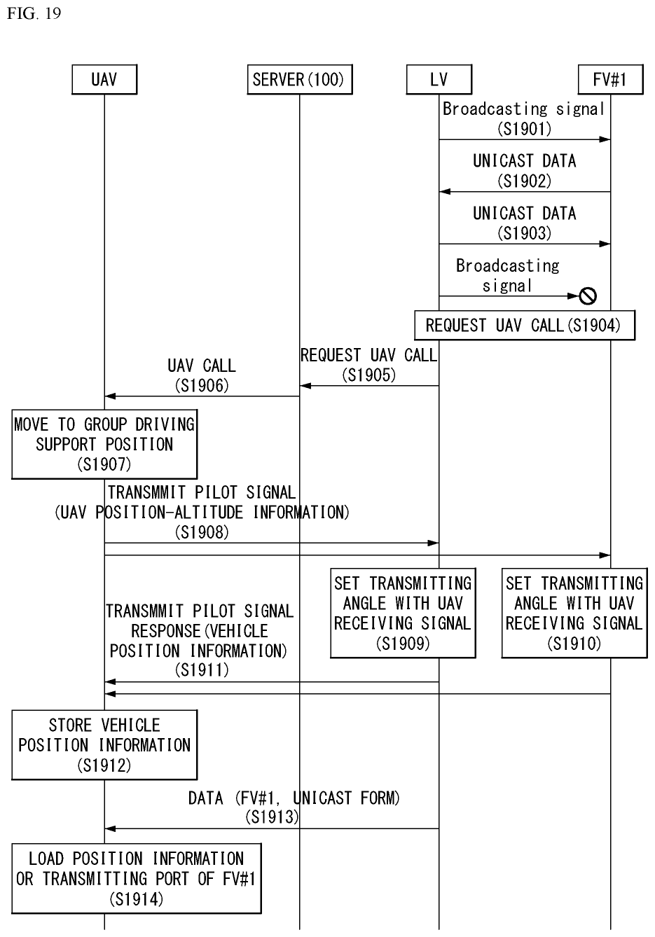

FIG. 19 is a flowchart illustrating a procedure of calling an UAV in an autonomous driving system.

Referring to FIG. 19, a procedure of calling an UAV is described as follows.

Through first step S1901 to third step S1903, the leader vehicle LV and the following vehicle FV set a communication direction. In first step S1901, the leader vehicle LV transmits a signal in a broadcast manner. In second step S1902, the following vehicle FV, having received the broadcasting signal transmits unicast data to the leader vehicle LV. In third step S1903, the leader vehicle LV, having received unicast data from the following vehicle FV designates the corresponding following vehicle and transmits the unicast data having a direction.

In fourth step S1904, the leader vehicle LV or the following vehicle FV checks a procedure of calling an UAV. The fourth step S1400 may correspond to the fifth step 1500 illustrated in FIG. 10.

In fifth step S1905, the leader vehicle LV or the following vehicle FV, having checked the procedure of calling the UAV requests a call of the UAV to a server 100.

In sixth step S1906, the server 100 calls an UAV in response to the UAV call request. The server 100 may call one or more UAVs according to the number of requested UAVs. Further, the server 100 may notify a position of each UAV to fly according to relative position information of the UAV.

In seventh step S1907, the UAV moves to a platooning position to relay communication in response to the call of the server 100.

In eighth step S1908, the UAV, having moved to the platooning position transmits a pilot signal to the leader vehicle LV and the following vehicle FV.

In ninth step S1909 and tenth step S1910, each of the leader vehicle LV and the following vehicle FV, having received the pilot signal sets a transmission angle. The transmission angle indicates a communication direction between the UAV and the leader vehicle LV or the UAV and the following vehicle FV.

In eleventh step S1911, the leader vehicle LV and the following vehicle FV provide vehicle position information to the UAV.

In twelfth step S1912, the UAV stores position information of the leader vehicle LV and the following vehicle FV.

In thirteenth step S1913 and fourteenth step S1914, the leader vehicle LV provides a control signal to the UAV, and the UAV relays the control signal to transmit the control signal to the following vehicle FV.

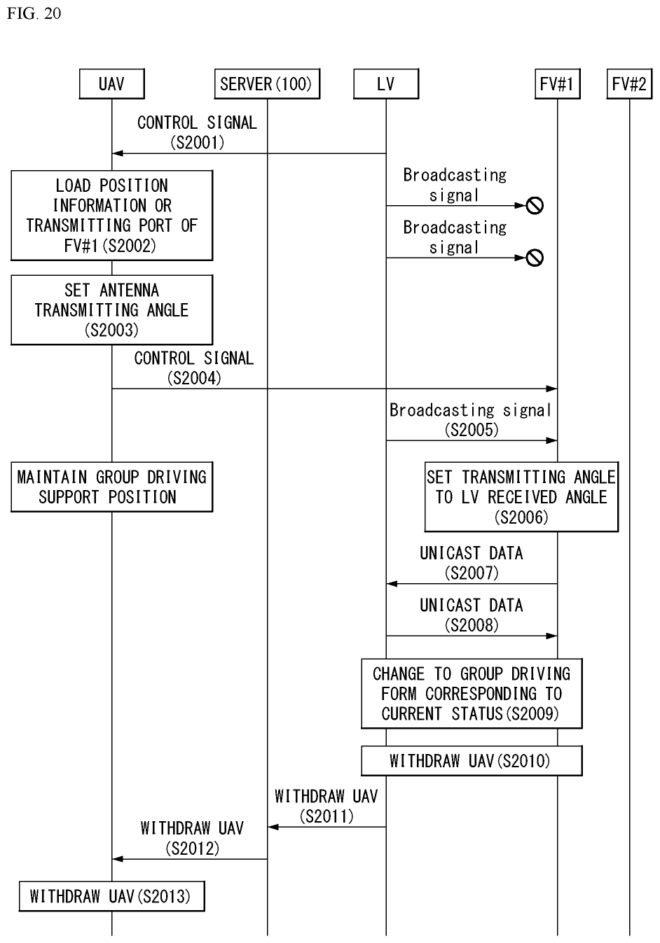

FIG. 20 is a flowchart illustrating a procedure of withdrawing an UAV in an autonomous driving system.

Referring to FIG. 20, through first step S2001 to fourth step S2004, the leader vehicle LV transmits a control signal to the following vehicle FV through the UAV. In this way, in a process of communicating between the leader vehicle LV and the following vehicle FV using an UAV, the leader vehicle transmits a broadcast signal.

In fifth step S2005 and sixth step S2006, the following vehicle FV, having received the broadcast signal from the leader vehicle LV sets a communication direction in a direction of the leader vehicle LV.

In seventh step S2007 to ninth step S2009, the leader vehicle LV or the following vehicle FV, having checked that direct communication is available without using relay of the UAV maintains a platooning form in which communicating is available.

In tenth step S2010 to thirteenth step S2013, the leader vehicle LV or the following vehicle FV transmits a withdrawal request of the UAV to the server 100. The server 100 transmits a withdrawal command to the UAV, and the UAV stops and withdraws a relay role of platooning.

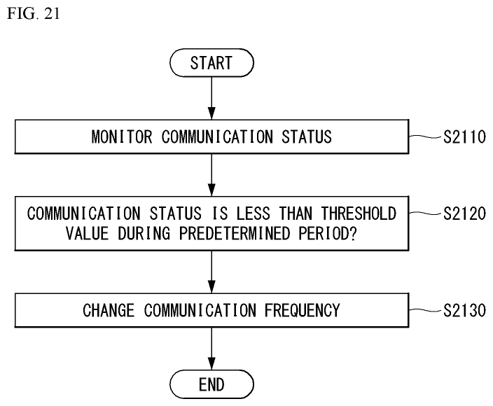

FIG. 21 is a flowchart illustrating an embodiment of changing a communication frequency.

Referring to FIG. 21, in first step S2110, a communication status is monitored. Operation of monitoring the communication status may be performed by the leader vehicle LV or the following vehicle FV. A communication status of platooning may be determined based on at least one of channel congestion, reception sensitivity, a packet error ratio (PER), received signal strength indication (RSSI), a signal to noise ratio (SNR), and signal-to-interference-plus-noise ratio (SINR).

First step S2110 of FIG. 21 may correspond to first step S1100 of FIG. 10. Further, first step S2110 of FIG. 21 may be a procedure after fourth step S1400 or fifth step S1500 of FIG. 10.

In second step S2120, a period is counted in which the communication status is maintained to a value less than a threshold value.

In third step S2130, when the communication status is maintained to a value less than a threshold value for a predetermined period, the communication frequency is changed. For example, when 5G communication of a frequency of a high frequency band or an ultrahigh frequency band is generally used and when the communication status is a value less than a threshold value for a predetermined period, an LTE frequency may be used.

The embodiment illustrated in FIG. 21 may be performed after step of calling an UAV to compensate the disadvantage of a process of relaying a control signal using an UAV. For example, in platooning, a data transmission amount may be increased using 5G communication in which a communication frequency is a high frequency and in which a frequency band is large. When an UAV is used, a communication blind spot may be eliminated. However, when a control signal is relayed using the UAV, latency becomes longer, compared with direct communication between the leader vehicle LV and the following vehicle FV.

In the embodiment illustrated in FIG. 21, in a process of relaying a control signal using an UAV, when a waiting time of a communication signal becomes long, LTE communication having a low frequency may be used instead of 5G communication having strong directivity. That is, by increasing a probability that direct communication between the leader vehicle LV and the following vehicle FV is available, the UAV can be withdrawn and as a result, latency can be reduced.

The configurations described in the present specification are not to be construed as limiting in all respects, but should be considered as illustrative. The scope of the invention should be determined by reasonable interpretation of the appended claims and all modifications within the equivalent scope of the invention are included within the scope of the invention.

According to the present invention, when a communication blind spot occurs, it is possible to deviate from a state of communication failure by changing a line of vehicles in platooning.

According to the present invention, when a communication blind spot occurs, it is possible to deviate from a communication failure state by relaying communication using an UAV.

What is claimed is:

1. A method of controlling platooning in which following vehicles receiving and driving a control signal from a leader vehicle and a communicator of the leader vehicle drive in a group, the method comprising:
monitoring a communication status of the platooning;
determining, based on the communication status being less than a predetermined threshold value, a communication blind spot between the leader vehicle and the following vehicle; and
changing, based on the following vehicle being positioned at the communication blind spot, a relative position of the following vehicle within the platooning.

2. The method of claim 1, wherein the determining of a communication blind spot comprises:
determining, when the communicator of the leader vehicle is positioned at an upper portion of the vehicle, that the following vehicle is positioned at the communication blind spot, based on the difference of the heights of the leader vehicle and the following vehicle from a driving route.

3. The method of claim 2, wherein the changing of a relative position of the following vehicle comprises increasing a distance between the leader vehicle and the following vehicle.

4. The method of claim 1, wherein the checking of a communication blind spot comprises:
determining, when the communicator of the leader vehicle is disposed at a side mirror of the vehicle, that the following vehicle is positioned at the communication blind spot, based on a heading direction of the leader vehicle being greater than or equal to a predetermined threshold angle.

5. The method of claim 4, wherein the changing of a relative position of the following vehicle comprises changing a lane of the leader vehicle or the following vehicle.

6. The method of claim 1, further comprising calling, an unmanned aerial vehicle for relaying the control signal from the leader vehicle, based on confirming that a relative position change of the following vehicle is unavailable.

7. The method of claim 6, wherein the platooning comprises a plurality of following vehicles,
wherein the calling of an unmanned aerial vehicle comprises calling a first unmanned aerial vehicle for relaying first group following vehicles among the following vehicles, and a second unmanned aerial vehicle for receiving a control signal from the first unmanned aerial vehicle and relaying second group following vehicles among the following vehicles.

8. The method of claim 7, wherein the platooning classifies following vehicles having a poor communication status into the second group following vehicles.

9. The method of claim 8, further comprising setting a flight position of the second unmanned aerial vehicle such that the sum of separation distances between the second unmanned aerial vehicle and each of the second group following vehicles is a minimum.

10. The method of claim 1, wherein the monitoring a communication status comprises:
counting a communication failure period in which the communication status is remained to a value less than the threshold value; and
changing, based on confirming that the communication failure period is equal to or greater than a predetermined threshold time, a communication frequency of the platooning to a frequency of low directivity.

11. The method of claim 10, wherein the monitoring a communication status comprises determining latency in 5G communication, and
wherein the changing of a communication frequency comprises changing from a frequency of 5G communication to an LTE-based frequency.

12. The method of claim 1, wherein the platooning performs communication based on 5G communication,
wherein the method further comprises: after calling the unmanned aerial vehicle,
calculating communication latency of the following vehicle;
changing, based on confirming that a period in which the communication latency is greater than or equal to a predetermined threshold time reaches a predetermined period, a communication means of the platooning to LTE-based communication.

13. The method of claim 1, further comprising calling, based on the following vehicle being not positioned at the communication blind spot, an unmanned aerial vehicle for relaying the control signal from the leader vehicle.

14. The method of claim 13, further comprising defining a corresponding driving region to a communication blind spot and storing position information of the communication blind spot.
